(19) United States
(12) Patent Application Publication
(10) Pub. No.: US 2013/0147696 A1
(43) Pub. Date: Jun. 13, 2013

(54) Display Moving Image Quality Improvement In 3D Barrier Type Display

(71) Applicant: Jani Edvin Penttilä, Lempaala (FI)

(72) Inventor: Jani Edvin Penttilä, Lempaala (FI)

(21) Appl. No.: 13/316,848

(22) Filed: Dec. 12, 2011

(51) Int. Cl. G09G 3/34

(52) U.S. Cl. 345/85

(57) ABSTRACT

A method to display moving images is described. The method includes shuttering one or more display pixels in a plurality of display pixels. Shuttering blocks substantially all light emanating from the display pixel. The method also includes, while shuttered, refreshing the one or more display pixels and allowing the one or more display pixels to stabilize. Backlights for the shuttered display pixels may be turned off while shuttered. After the one or more display pixels have substantially stabilized, unshuttering the one or more display pixels is included in the method. Apparatus and computer readable media are also described.

### TECHNICAL FIELD

The exemplary and non-limiting embodiments of this invention relate generally to image display systems, methods, devices and computer programs and, more specifically, relate to displaying moving images.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

CRT cathode ray tube

FPS frames per second

IC integrated circuit

ITO Indium Tin Oxide

LC liquid crystal

LCD liquid crystal display

MiQ moving image quality

MQ motion quality

OLED organic light-emitting diode

A liquid crystal display (LCD) is a hold type display creating hold type images. In contrast, a cathode ray tube (CRT) produces impulse type images. The human eye is more sensitive to impulse type image than hold type image. Thus, the human eye can see a moving impulse type image more sharply than a moving hold type image.

In the LCD display technology area different methods have been used to improve perceived motion quality (MQ), also referred to as moving image quality (MiQ), in TV and gaming applications. Liquid crystal (LC) material typically requires some time to stabilize in response to instructions. This delay may be interpreted as a blurring in moving images.

In mobile device systems, MQ improvements are still being developed. However, such improvements face additional difficulties when being implemented in a mobile-friendly way. In other words, methods usable in larger device, e.g., TVs, may require extensive image processing and power to work efficiently. These resources are scarcer in a mobile environment. Also, some methods (e.g., localized backlight or scanning backlight), may be mechanically challenging to be implement in the limited space of a mobile display.

Various motion quality methods currently exist. For example, LCD pixel overdrive, black frame insertion (or backlight blinking), scanning backlight and generation of additional artificial frames in the data stream to increase the display frame rate

Operation of the backlight blinking method emulates the behavior of an impulse type display (e.g., “old” CRT TV). First, an image is uploaded to a display panel. Then the image is allowed to stabilize. Only after the pixels have been stabilized, a backlight is quickly blinked on (this may occur many times in one second). Since this simulates an impulse image, the human eye can track the ‘motion’ displayed more clearly than in a traditional hold type display.

The scanning backlight method (similar to the blinking backlight) may operate on one row (or set of rows) of the display at a time. For example, each row (or set of rows) may be displayed in a ‘top-to-bottom’ technique. In this technique, one horizontal row may be displayed while the next row vertically down from that row is stabilizing. Once the lower row is stabilized, the backlight for that row is blinked on. This process may begin from the top of the display and proceed down to the bottom.

The scanning backlight method has quite a few downsides. It requires a complex and difficult mechanical construction. For example, only a limited number of LEDs may be available due to mechanical size. The scanning backlight method also uses individual light sources (e.g., LEDs) operated in synchronization. There are also optical challenges, for example, maintaining backlight uniformity in white content.

What is needed is an efficient technique to display moving images on hold type displays.

### SUMMARY

The below summary section is intended to be merely exemplary and non-limiting.

The foregoing and other problems are overcome, and other advantages are realized, by the use of the exemplary embodiments of this invention.

In a first aspect thereof an exemplary embodiment of this invention provides a method to display moving images. The method includes shuttering one or more display pixels in a plurality of display pixels, where shuttering blocks substantially all light emanating from the display pixel. The method also includes, while shuttered, refreshing the one or more display pixels and allowing the one or more display pixels to stabilize. After the one or more display pixels have substantially stabilized, unshuttering the one or more display pixels is included in the method. Unshuttering allows light to emanate from the display pixel.

In another aspect thereof an exemplary embodiment of this invention provides an apparatus to display moving images. The apparatus includes at least one processor; and at least one memory including computer program code. The at least one memory and the computer program code are configured to, with the at least one processor, cause the apparatus to perform actions. The actions include shuttering one or more display pixels in a plurality of display pixels. The actions also include, while shuttered, refreshing the one or more display pixels and allowing the one or more display pixels to stabilize. After the one or more display pixels have substantially stabilized, unshuttering the one or more display pixels is included in the actions.

In a further aspect thereof an exemplary embodiment of this invention provides a computer readable medium to display moving images. The computer readable medium is tangibly encoded with a computer program executable by a processor to perform actions. The actions include shuttering one or more display pixels in a plurality of display pixels. The actions also include, while shuttered, refreshing the one or more display pixels and allowing the one or more display pixels to stabilize. After the one or more display pixels have substantially stabilized, unshuttering the one or more display pixels is included in the actions.

In another aspect thereof an exemplary embodiment of this invention provides an apparatus to display moving images. The apparatus includes means for shuttering one or more display pixels in a plurality of display pixels. The apparatus also includes means for refreshing the one or more display pixels while shuttered and means for allowing the one or more display pixels to stabilize while shuttered. Means for unshuttering the one or more display pixels after the one or more display pixels have substantially stabilized are included in the apparatus.

### BRIEF DESCRIPTION OF THE DRAWINGS

The foregoing and other aspects of exemplary embodiments of this invention are made more evident in the following Detailed Description, when read in conjunction with the attached Drawing Figures, wherein:

FIG. 1 shows a simplified block diagram of an exemplary electronic device that is suitable for use in practicing various exemplary embodiments of this invention.

FIG. 2 shows a more particularized block diagram of an exemplary device such as that shown at FIG. 1.

FIG. 3 illustrates a simplified block diagram of an exemplary display that is suitable for use in practicing various exemplary embodiments of this invention.

FIG. 4 demonstrates a simplified exemplary display that is suitable for use in practicing various exemplary embodiments of this invention.

FIG. 5 demonstrates another simplified exemplary display that is suitable for use in practicing various exemplary embodiments of this invention.

FIG. 6 illustrates a cross-section of a simplified block diagram of an exemplary display such as that shown at FIG. 3.

FIG. 7 is a logic flow diagram that illustrates the operation of an exemplary method, and a result of execution of computer program instructions embodied on a computer readable memory, in accordance with various exemplary embodiments of this invention.

### DETAILED DESCRIPTION

Various exemplary embodiments in accordance with this invention provide a means for displaying moving images. In one, non-limiting example, a series of shutters may be used to ‘shutter’ a portion of the display (e.g., by blocking most of the light emitting from that portion) while display elements (e.g., LCDs) are allowed to stabilize. This produces a similar effect to the backlight blinking method and the scanning backlight technology. Additionally, lighting elements (e.g., LEDs) may be turned off while the shutters are closed in order to save energy. Alternatively, the display elements may include organic light-emitting diodes (OLED) which also function as lighting elements.

As used herein, ‘shuttering’ may refer to blocking light from a display element (e.g., an OLED, LED, a backlit LCD, etc.) and/or light directed to a display element (e.g., to an LCD pixel). Similarly, ‘unshuttering’ refers to unblocking light from a display element and/or directed to a display element.

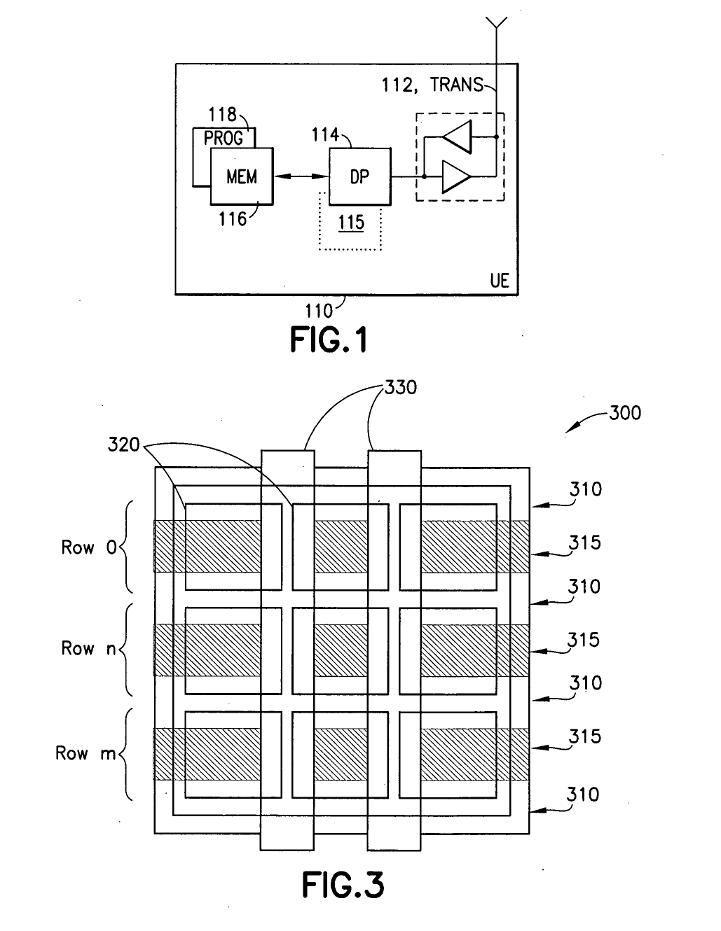

Before describing in further detail various exemplary embodiments of this invention, reference is made to FIG. 1 for illustrating a simplified block diagram of various electronic devices and apparatus that are suitable for use in practicing exemplary embodiments of this invention.

FIG. 1 illustrates an electronic device, such as a mobile communication device which may be referred to as a device 110. The device 110 includes a controller, such as a computer or a data processor (DP) 114 and a computer-readable memory medium embodied as a memory (MEM) 116 that stores a program of computer instructions (PROG) 118. Device 110 may also include a suitable wireless interface, such as radio frequency (RF) transceiver 112, for bidirectional wireless communications.

The PROGs 118 is assumed to include program instructions that, when executed by the associated DP 114, enable the device to operate in accordance with exemplary embodiments of this invention, as will be discussed below in greater detail.

That is, various exemplary embodiments of this invention may be implemented at least in part by computer software executable by the DP 114 of the device 110, or by hardware, or by a combination of software and hardware (and firmware). The device 110 may also include dedicated processors, for example image processor 115.

In general, the various embodiments of the device 110 can include, but are not limited to, cellular telephones, tablets, personal digital assistants (PDAs), portable computers having wireless communication capabilities, image capture devices such as digital cameras, gaming devices, music storage and playback appliances having display capabilities, Internet appliances permitting wireless Internet access and browsing, as well as portable units or terminals that incorporate combinations of such functions.

The computer readable MEM 116 may be of any type suitable to the local technical environment and may be implemented using any suitable data storage technology, such as semiconductor based memory devices, flash memory, magnetic memory devices and systems, optical memory devices and systems, fixed memory and removable memory. The DP 114 may be of any type suitable to the local technical environment, and may include one or more of general purpose computers, special purpose computers, microprocessors, digital signal processors (DSPs) and processors based on a multicore processor architecture, as non-limiting examples. The wireless interface (e.g., RF transceivers 112) may be of any type suitable to the local technical environment and may be implemented using any suitable communication technology such as individual transmitters, receivers, transceivers or a combination of such components.

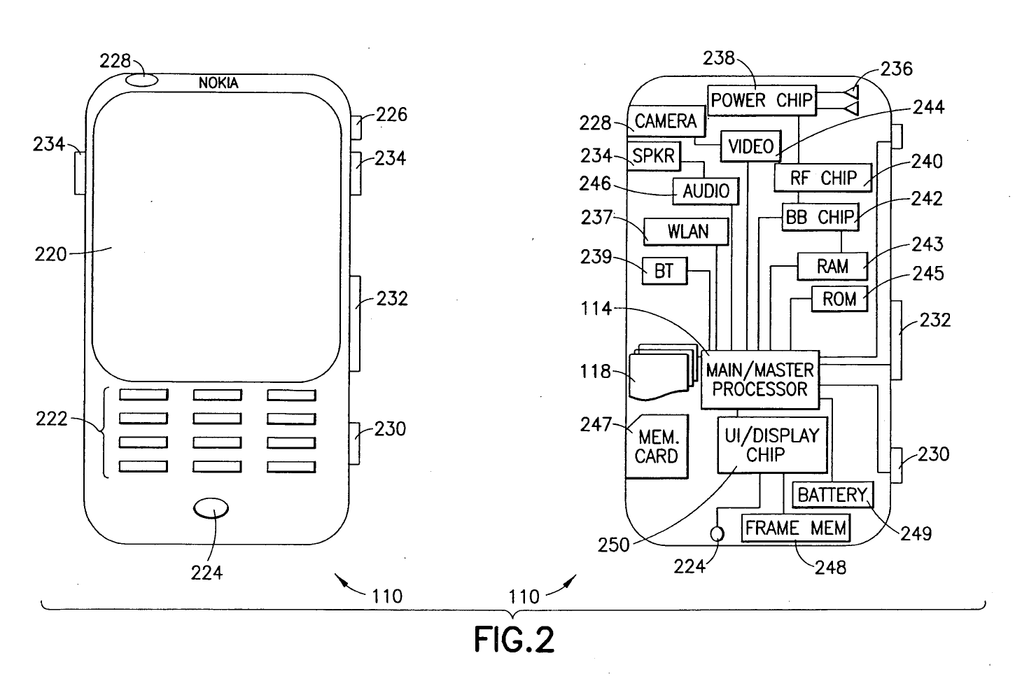

FIG. 2 illustrates further detail of an exemplary device in both plan view (left) and sectional view (right), and the invention may be embodied in one or some combination of those more function-specific components. At FIG. 2 the device 110 has a graphical display interface 220 and a user interface 222 illustrated as a keypad but understood as also encompassing touch-screen technology at the graphical display interface 220 and voice-recognition technology received at the microphone 224. A power actuator 226 controls the device being turned on and off by the user. The exemplary device 110 may have a camera 228 which is shown as being forward facing (e.g., for video calls) but may alternatively or additionally be rearward facing (e.g., for capturing images and video for local storage). The camera 228 is controlled by a shutter actuator 230 and optionally by a zoom actuator 232 which may alternatively function as a volume adjustment for the speaker(s) 234 when the camera 228 is not in an active mode.

Within the sectional view of FIG. 2 are seen multiple transmit/receive antennas 236 that are typically used for cellular communication. The antennas 236 may be multi-band for use with other radios in the device. The operable ground plane for the antennas 236 is shown by shading as spanning the entire space enclosed by the device housing though in some embodiments the ground plane may be limited to a smaller area, such as disposed on a printed wiring board on which the power chip 238 is formed. The power chip 238 controls power amplification on the channels being transmitted and/or across the antennas that transmit simultaneously where spatial diversity is used, and amplifies the received signals. The power chip 238 outputs the amplified received signal to the radio-frequency (RF) chip 240 which demodulates and downconverts the signal for baseband processing. The baseband (BB) chip 242 detects the signal which is then converted to a bit-stream and finally decoded. Similar processing occurs in reverse for signals generated in the apparatus 110 and transmitted from it.

Signals to and from the camera 228 pass through an image/video processor 244 which encodes and decodes the various image frames. A separate audio processor 246 may also be present controlling signals to and from the speakers 234 and the microphone 224. The graphical display interface 220 is refreshed from a frame memory 248 as controlled by a user interface chip 250 which may process signals to and from the display interface 220 and/or additionally process user inputs from the keypad 222 and elsewhere.

Certain embodiments of the device 110 may also include one or more secondary radios such as a wireless local area network radio WLAN 237 and a Bluetooth® radio 239, which may incorporate an antenna on-chip or be coupled to an off-chip antenna. Throughout the apparatus are various memories such as random access memory RAM 243, read only memory ROM 245, and in some embodiments removable memory such as the illustrated memory card 247. The various programs 118 are stored in one or more of these memories. All of these components within the device 110 are normally powered by a portable power supply such as a battery 249.

Processors 238, 240, 242, 244, 246, 250, if embodied as separate entities in a device 110, may operate in a slave relationship to the main processor 114, which may then be in a master relationship to them. Embodiments of this invention are most relevant to the image processor 115, graphical display interface 220, frame memory 248 and user interface chip 250, though it is noted that other embodiments need not be disposed there but may be disposed across various chips and memories as shown or disposed within another processor that combines some of the functions described above for FIG. 2. Any or all of these various processors of FIG. 2 access one or more of the various memories, which may be on-chip with the processor or separate therefrom. Similar function-specific components that are directed toward communications over a network broader than a piconet (e.g., components 236, 238, 240, 242-245 and 247) may also be disposed in an access node, which may have an array of tower-mounted antennas.

Note that the various chips (e.g., 238, 240, 242, etc.) that were described above may be combined into a fewer number than described and, in a most compact case, may all be embodied physically within a single chip.

Recent developments in 3-dimensional (3D) displays use parallax barrier networks to limit visibility of parts of a display. For example, some pixels may be visible only when viewed at the correct angle. The parallax barrier network may be located between a light emitting display element (e.g., a LED-lit backlight) and a viewer. In some designs the barrier is between the light emitting display elements and other display elements (e.g., LCDs, etc.). In such a way, light from some pixels is blocked from view by one eye of the viewer (e.g., left) while still remaining visible to the other eye (e.g., right). The parallax barrier network may include a series of parallel barriers which run vertical to the orientation of the display. Some parallax barrier networks may be multi-orienational where the parallax barriers are arranged in both horizontal and vertical directions. The barriers may then be activated depending on the orientation of the display (e.g., portrait or landscape). Note that a parallax barrier network generally allows some light to be visible (e.g., to only one eye).

FIG. 3 illustrates a simplified block diagram of an exemplary display that is suitable for use in practicing various exemplary embodiments of this invention. A portion of the display 300 (e.g., graphical display interface 220) is shown. The portion 300 is further subdivided into display pixels 320. An array of pixels may be referred to as a display panel.

Overlaying the pixels is a cross-hatch pattern of shutters which may be used to block light when closed (or shuttered). These shutters include horizontal (or portrait) shutters 310 and 315 and vertical (or landscape) shutters 330. Shutters 330 may also be used as a parallax barrier network in order to provide a 3D effect to images displayed. Horizontal (or portrait) shutters 310 and 315 and vertical (or landscape) shutters 330 may be used depending on if the display is configured for multi-orientation 3D or single orientation 3D. Additional vertical shutters (not shown) may be located between shutters 330 similar to shutters 310 and 315. Shutters 310, 315 and 330 may be formulated from invisible ITO conductor on glass with a LC shell.

While the following description of the exemplary embodiment illustrated in FIG. 3 is described in relation to the orientation shown (e.g., where shutters 330 are vertical to the orientation of the display), it should be appreciated that the exemplary embodiments of this invention are not limited for use with only this one particular orientation. For example, when the portion of the display 300 is rotated 90°, shutters 310 may then be used as a parallax barrier network.

In an exemplary embodiment in accordance with this invention, a LCD pixel is refreshed while barriers affecting that pixel are turned ‘on’ (shuttered). The LCD pixel is allowed some time until the LC material has stabilized. Then the barriers for the LCD pixel are turned “off” (unshuttered). This process is repeated for each LCD pixels (or row of LCD pixels) in the display.

Images displayed using the exemplary embodiment allow the viewer to see an impulse effect in moving image content. Additionally, since the display is allowed to stabilize, motion blur is minimized or removed entirely.

The shutters may be implemented using 3D circuitry, for example, a modified parallax barrier network. The parallax barrier network may include additional barriers allowing full blockage of light from portions of the display. The barriers of the parallax barrier network may be individually controlled in order to block almost all the light from different portions of the display while allowing light from other portions. The barriers may also be able to shutter very quickly in order to meet FPS demands. The height of an area where the barriers are open may be configurable and may also dependent on the display pixel physical properties.

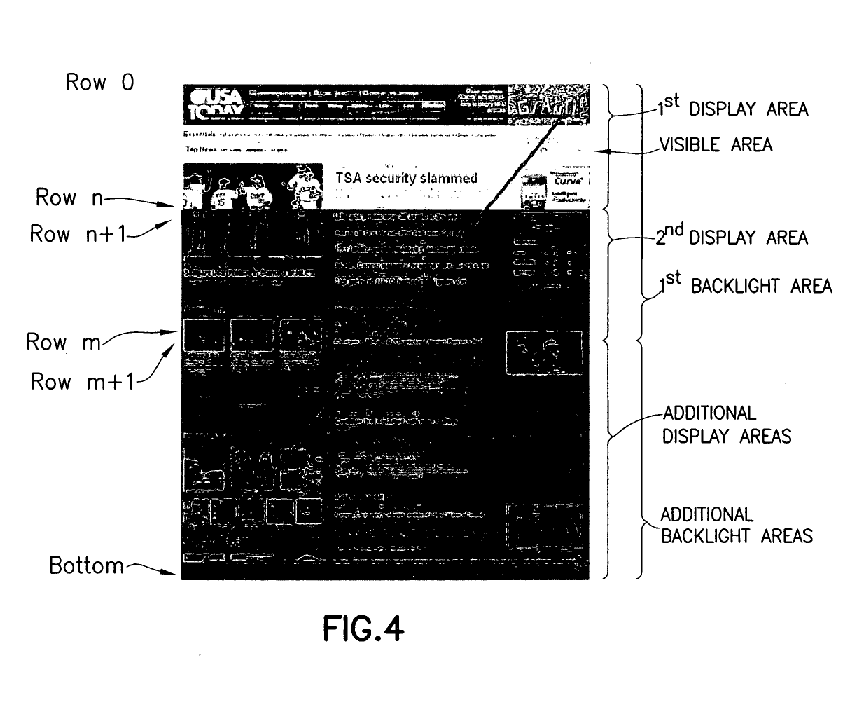

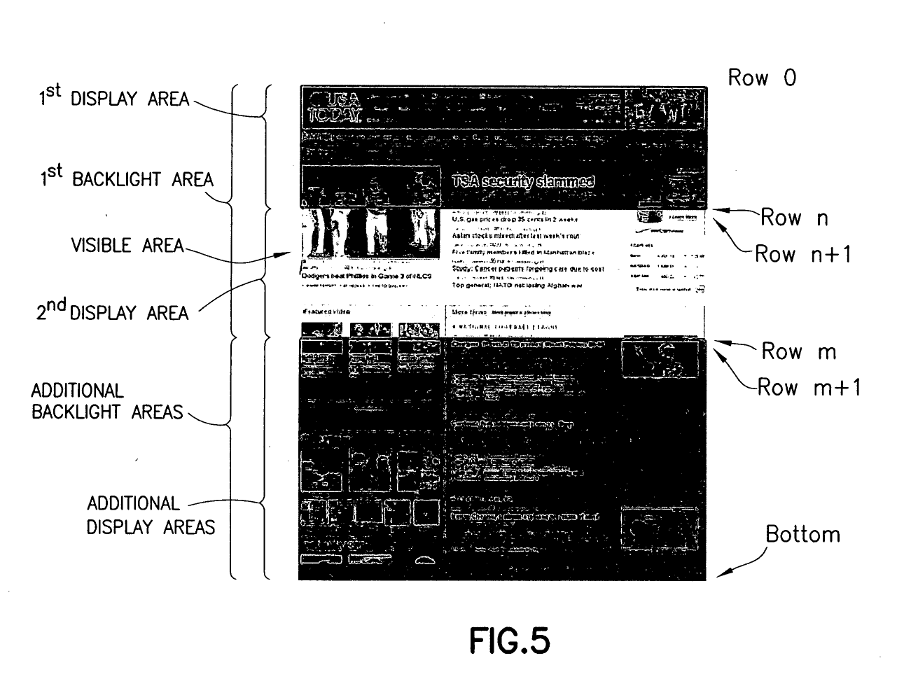

FIGS. 4 and 5 demonstrate a simplified exemplary display that is suitable for use in practicing various exemplary embodiments of this invention. A first display area includes pixels in row 0 through row n and a second display area includes pixels in row n+1 through row m. Likewise, the display from row m+1 to the bottom of the display may be dived divided into a number of additional display areas.

As a non-limiting example, the first display area and the second display area are lit by a first backlight area. The additional display areas may be lit by one or more additional backlight areas. Each backlight area provides light from a single source (e.g., a single LED) or a jointly controlled set of sources (e.g., a set of LEDs operated in unison).

In FIG. 4 shutters (or barriers) covering the first display area are open (unshuttered). This allows light from those pixels to be visible to the viewer. Rows n+1 through to the bottom of the display are closed (shuttered) preventing light from being visible. During this time, display pixels (e.g., LCD pixels) in row n+1 through to the bottom may be stabilizing.

As shown, the first backlight area is providing light for the first display area and the second display area. Since the shutters for the first display area are open, the first display area is visible. The second display area is not visible due to the associated shutters are closed. The additional backlight areas may be turned off as the shutters for these areas are closed.

In FIG. 5 the shutters covering the first display area are closed (shuttered). At this time the display pixels in those rows may be refreshed and given time to stabilize. Since the display pixels in the second display area should now be sufficiently stabilized, the shutters are opened. Rows m+1 through to the bottom of the display are closed (shuttered) and continue to stabilize.

As shown, the first backlight area continues to providing light for the first display area and the second display area. Since the shutters for the first display area are now closed, the first display area is no longer visible. The second display area is now visible due to the associated shutters have been opened. Since the additional display areas are still not visible, the additional backlight areas may be left off. Alternatively, one or more of the additional backlight areas may be starting up in anticipation of the associated display areas being unshuttered.

While the above is described in relation to a ‘top-to-bottom’ technique, it should be appreciated that the exemplary embodiments of this invention are not limited for use with only this one particular technique. Other techniques may also be used, for example, ‘bottom-to-top’, where rows are first refreshed from the bottom of the display to the top; ‘left-to-right’, where columns are refreshed from the left side of the display to the right; ‘right-to-left’, where columns are refreshed from the right side of the display to the left; etc.

Note that the embodiment of the display in FIGS. 4 and 5 show only one set of rows visible at a time, in further embodiments more than one set of rows may be visible at one time, for example, every other row, every tenth row, etc. Alternatively, a row (or set of rows) may be allowed additional visibility time such that one or more subsequent row may be unshuttered before shuttering a previous row.

Another embodiment may also use shuttering for a sub-set of rows on the display. For example, when only the top half of the display is used for showing a moving image, only those rows in the top half of the display are scanned using the shuttering technique described. The static area of the image may be displayed in the convention manner.

In a LCD display, brightness uniformity may suffer due to the unshuttered area(s) being brighter. In an OLED display, this may be compensated as the brightness of each area may be independently addressed.

In a further embodiment of the display above, vertical barriers may be used simultaneously with the described shuttering. The additional barriers may also block any light that is not blocked by the horizontal barriers creating a more effective shutter.

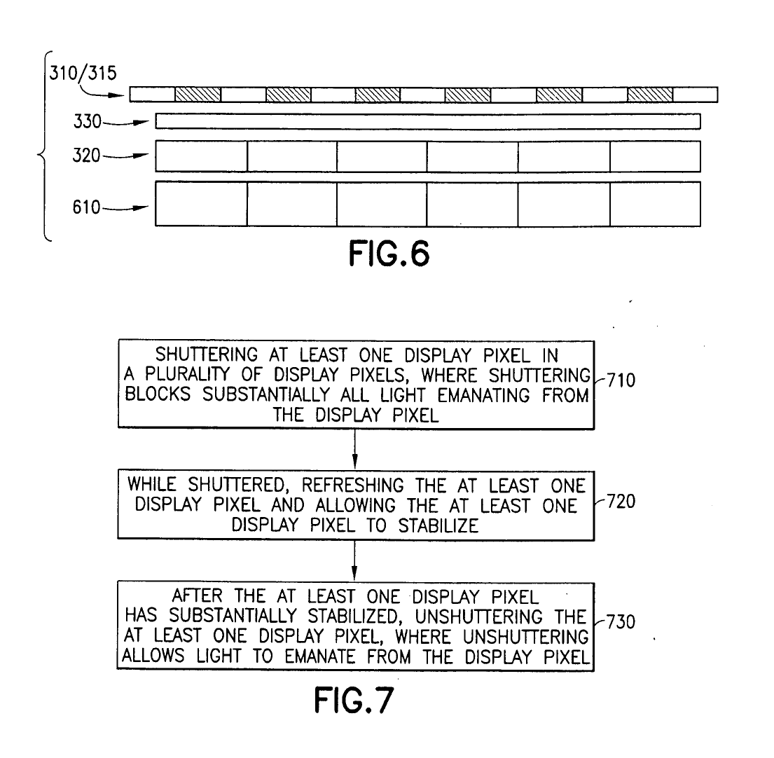

FIG. 6 illustrates a cross-section of a simplified block diagram of an exemplary display such as that shown at FIG. 3. As shown, shutters 310 and 315 and shutters 330 are layered on top of the display pixels 320. Below display pixels 320 is a set of light guides 610 reflecting light from light emitting display elements (e.g., LEDs) (not shown). Such LEDs may be located on the side/edge of the display and project light to the light guides 610.

LEDs for an area being shuttered may be turned off in order to provide additional power saving. Since the barriers prevent visibility of the area lit by the LEDs, the LEDs may be less precise than those required for backlight scanning. For example, the shutters may be sufficiently fast to block light from the LED while the LED is powering down. Likewise, the LEDs can be turned on prior to unshuttering.

Furthermore, a backlight for multiple display areas may be turned on (or off) based on the display areas needs. For example, if a first set of pixels are shuttered but a second set of pixels are to be visible the backlight may be turned on even though some pixels lit by the backlight are shuttered. Similarly, if a set of pixels are unshuttered but are not to be visible the backlight may be turned off (assuming no other pixels lit by the backlight are to be visible).

Additionally, the arrangement of shutters 310, 315 and 330 is a non-limiting example. As described above, the shutters 310, 315 and 330 may be disposed between the display pixels 320 and the light emitting display elements 610.

Based on the foregoing it should be apparent that the exemplary embodiments of this invention provide a method, apparatus and computer program(s) to display moving images.

FIG. 7 is a logic flow diagram that illustrates the operation of a method, and a result of execution of computer program instructions, in accordance with the exemplary embodiments of this invention. In accordance with these exemplary embodiments a method performs, at Block 710, a step of shuttering at least one display pixel in a plurality of display pixels. Shuttering blocks substantially all light emanating from the display pixel. While shuttered, the method performs, at Block 720, refreshing the at least one display pixel and allowing the at least one display pixel to stabilize. After the at least one display pixel has substantially stabilized, the method performs, at Block 730, unshuttering the at least one display pixel. Unshuttering allows light to emanate from the display pixel.

The various blocks shown in FIG. 7 may be viewed as method steps, and/or as operations that result from operation of computer program code, and/or as a plurality of coupled logic circuit elements constructed to carry out the associated function(s).

An exemplary embodiment in accordance with the invention is a method to display moving images. The method includes shuttering (e.g., by a processor controlling shutters) one or more display pixels in a plurality of display pixels. Shuttering blocks substantially all light emanating from the display pixel. The method also includes, while shuttered, refreshing (e.g., by a processor) the one or more display pixels and allowing the one or more display pixels to stabilize. After the one or more display pixels have substantially stabilized, unshuttering (e.g., by a processor controlling shutters) the one or more display pixels is included in the method. Unshuttering allows light to emanate from the display pixel.

In a further exemplary embodiment of the method above, the method includes when shuttering the one or more display pixels, turning off a backlight area for the one or more display pixels; and, when unshuttering the one or more display pixels, turning on the backlight area for the one or more display pixels. The backlight may be at least one light emitting diode. The backlight area may be turned off in response to shuttering the one or more display pixels. Likewise, the backlight area may be turned on prior to unshuttering the one or more display pixels.

In an additional exemplary embodiment of any one of the methods above, display pixels in the plurality of display pixels are liquid crystal display pixels or organic light emitting diode pixels.

In a further exemplary embodiment of any one of the methods above, shuttering includes activating one or more barriers in a parallax barrier network. The one or more barriers may be one or more horizontal barriers.

In an additional exemplary embodiment of any one of the methods above, the one or more display pixels includes a horizontal row of display pixels.

In a further exemplary embodiment of any one of the methods above, the one or more display pixels includes a first set of display pixels. The method also includes, while the first set of display pixels are unshuttered, shuttering a second set of display pixel in the plurality of display pixels and refreshing the second set of display pixel.

An additional exemplary embodiment in accordance with the invention is an apparatus to display moving images. The apparatus includes at least one processor; and at least one memory including computer program code. The at least one memory and the computer program code are configured to, with the at least one processor, cause the apparatus to perform actions. The actions include shuttering one or more display pixels in a plurality of display pixels. Shuttering blocks substantially all light emanating from the display pixel. The actions also include, while shuttered, refreshing the one or more display pixels and allowing the one or more display pixels to stabilize. After the one or more display pixels have substantially stabilized, unshuttering the one or more display pixels is included in the actions. Unshuttering allows light to emanate from the display pixel.

In a further exemplary embodiment of the apparatus above, the actions include when shuttering the one or more display pixels, turning off a backlight area for the one or more display pixels; and, when unshuttering the one or more display pixels, turning on the backlight area for the one or more display pixels. The backlight may be at least one light emitting diode. The backlight area may be turned off in response to shuttering the one or more display pixels. Likewise, the backlight area may be turned on prior to unshuttering the one or more display pixels.

In an additional exemplary embodiment of any one of the apparatus above, display pixels in the plurality of display pixels are liquid crystal display pixels or organic light emitting diode pixels.

In a further exemplary embodiment of any one of the apparatus above, shuttering includes activating one or more barriers in a parallax barrier network. The one or more barriers may be one or more horizontal barriers.

In an additional exemplary embodiment of any one of the apparatus above, the one or more display pixels includes a horizontal row of display pixels.

In a further exemplary embodiment of any one of the apparatus above, the one or more display pixels includes a first set of display pixels. The actions also include, while the first set of display pixels are unshuttered, shuttering a second set of display pixel in the plurality of display pixels and refreshing the second set of display pixel.

In an additional exemplary embodiment of any one of the apparatus above, the apparatus is embodied in an integrated circuit.

In a further exemplary embodiment of any one of the apparatus above, the apparatus is embodied in a mobile device.

An additional exemplary embodiment in accordance with the invention is a computer readable medium to display moving images. The computer readable medium is tangibly encoded with a computer program executable by a processor to perform actions. The actions include shuttering one or more display pixels in a plurality of display pixels. Shuttering blocks substantially all light emanating from the display pixel. The actions also include, while shuttered, refreshing the one or more display pixels and allowing the one or more display pixels to stabilize. After the one or more display pixels have substantially stabilized, unshuttering the one or more display pixels is included in the actions. Unshuttering allows light to emanate from the display pixel.

In a further exemplary embodiment of the computer readable medium above, the actions include when shuttering the one or more display pixels, turning off a backlight area for the one or more display pixels; and, when unshuttering the one or more display pixels, turning on the backlight area for the one or more display pixels. The backlight may be at least one light emitting diode. The backlight area may be turned off in response to shuttering the one or more display pixels. Likewise, the backlight area may be turned on prior to unshuttering the one or more display pixels.

In an additional exemplary embodiment of any one of the computer readable medium above, display pixels in the plurality of display pixels are liquid crystal display pixels or organic light emitting diode pixels.

In a further exemplary embodiment of any one of the computer readable medium above, shuttering includes activating one or more barriers in a parallax barrier network. The one or more barriers may be one or more horizontal barriers.

In an additional exemplary embodiment of any one of the computer readable medium above, the one or more display pixels includes a horizontal row of display pixels.

In a further exemplary embodiment of any one of the computer readable medium above, the one or more display pixels includes a first set of display pixels. The actions also include, while the first set of display pixels are unshuttered, shuttering a second set of display pixel in the plurality of display pixels and refreshing the second set of display pixel.

In an additional exemplary embodiment of any one of the computer readable medium above, the computer readable medium is a non-transitory computer readable medium (e.g., CD-ROM, flash memory, RAM, etc.).

A further exemplary embodiment in accordance with the invention is an apparatus to display moving images. The apparatus includes means for shuttering (e.g., a processor controlling shutters) one or more display pixels in a plurality of display pixels. Shuttering blocks substantially all light emanating from the display pixel. The apparatus also includes means for refreshing (e.g., by a processor) the one or more display pixels while shuttered and means for allowing (e.g., a processor) the one or more display pixels to stabilize while shuttered. Means for unshuttering (e.g., a processor controlling shutters) the one or more display pixels after the one or more display pixels have substantially stabilized are included in the apparatus. Unshuttering allows light to emanate from the display pixel.

In an additional exemplary embodiment of the method above, the apparatus includes means for turning off a backlight area for the one or more display pixels when shuttering the one or more display pixels; and means for turning on the backlight area for the one or more display pixels when unshuttering the one or more display pixels. The backlight may be at least one light emitting diode. The backlight area may be turned off in response to shuttering the one or more display pixels. Likewise, the backlight area may be turned on prior to unshuttering the one or more display pixels.

In a further exemplary embodiment of any one of the apparatus above, display pixels in the plurality of display pixels are liquid crystal display pixels or organic light emitting diode pixels.

In an additional exemplary embodiment of any one of the apparatus above, the shuttering means includes means for activating one or more barriers in a parallax barrier network. The one or more barriers may be one or more horizontal barriers.

In a further exemplary embodiment of any one of the apparatus above, the one or more display pixels includes a horizontal row of display pixels.

In an additional exemplary embodiment of any one of the apparatus above, the one or more display pixels includes a first set of display pixels. The apparatus also includes means for shuttering a second set of display pixel in the plurality of display pixels while the first set of display pixels are unshuttered and means for refreshing the second set of display pixel while the first set of display pixels are unshuttered.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
shuttering at least one display pixel in a plurality of display pixels, where shuttering blocks substantially all light emanating from the display pixel;
while shuttered, refreshing the at least one display pixel and allowing the at least one display pixel to stabilize; and
after the at least one display pixel has substantially stabilized, unshuttering the at least one display pixel, where unshuttering allows light to emanate from the display pixel.

2. The method of claim 1, further comprising:
turning off a backlight configured to illuminate a group of display pixels when none of the group of display pixels are to be visible; and,
turning on the backlight when at least one display pixel of the group of display pixels is to be visible.

3. The method of claim 2, where the backlight is at least one light emitting diode.

4. The method of claim 1, where display pixels in the plurality of display pixels are one of: liquid crystal display pixels and organic light emitting diode pixels.

5. The method of claim 1, where shuttering comprises activating at least one barrier in a parallax barrier network.

6. The method of claim 5, where the at least one barrier is a horizontal barrier.

7. The method of claim 1, where the at least one display pixel comprises a horizontal row of display pixels.

8. The method of claim 1, where the at least one display pixel comprises a first set of display pixels, and
the method further comprises, while the first set of display pixels are unshuttered, shuttering a second set of display pixel in the plurality of display pixels and refreshing the second set of display pixel.

9. An apparatus, comprising at least one processor; and at least one memory including computer program code, the at least one memory and the computer program code configured to, with the at least one processor, cause the apparatus to perform at least the following:
to shutter at least one display pixel in a plurality of display pixels, where shuttering blocks substantially all light emanating from the display pixel;
while shuttered, to refresh the at least one display pixel and allowing the at least one display pixel to stabilize; and
to unshutter the at least one display pixel after the at least one display pixel has substantially stabilized, where unshuttering allows light to emanate from the display pixel.

10. The apparatus of claim 9, where the at least one memory and the computer program code are further configured to cause the apparatus:
to turn off a backlight configured to illuminate a group of display pixels when none of the group of display pixels are to be visible; and,
to turn on the backlight when at least one display pixel of the group of display pixels is to be visible.

11. The apparatus of claim 9, where the at least one memory and the computer program code are further configured to cause the apparatus, when shuttering, to activate at least one barrier in a parallax barrier network.

12. The apparatus of claim 9, where the at least one display pixel comprises a first set of display pixels, and
where the at least one memory and the computer program code are further configured to cause the apparatus, while the first set of display pixels are unshuttered, to shutter a second set of display pixel in the plurality of display pixels and refreshing the second set of display pixel.

13. A computer readable medium tangibly encoded with a computer program executable by a processor to perform actions comprising:
shuttering at least one display pixel in a plurality of display pixels, where shuttering blocks substantially all light emanating from the display pixel;
while shuttered, refreshing the at least one display pixel and allowing the at least one display pixel to stabilize; and
after the at least one display pixel has substantially stabilized, unshuttering the at least one display pixel, where unshuttering allows light to emanate from the display pixel.

14. The computer readable medium of claim 13, where the actions further comprise:
turning off a backlight configured to illuminate a group of display pixels when none of the group of display pixels are to be visible; and,
turning on the backlight when at least one display pixel of the group of display pixels is to be visible.

15. The computer readable medium of claim 13, where shuttering comprises activating at least one barrier in a parallax barrier network.

16. The computer readable medium of claim 13, where the at least one display pixel comprises a first set of display pixels, and
the actions further comprise, while the first set of display pixels are unshuttered, shuttering a second set of display pixel in the plurality of display pixels and refreshing the second set of display pixel.

17. An apparatus comprising:
shuttering at least one display pixel in a plurality of display pixels, where shuttering blocks substantially all light emanating from the display pixel;
means for refreshing the at least one display pixel while shuttered;
means for allowing the at least one display pixel to stabilize while shuttered; and
means for unshuttering the at least one display pixel, where unshuttering allows light to emanate from the display pixel after the at least one display pixel has substantially stabilized.

18. The apparatus of claim 17, where the apparatus further comprises:
means for turning off a backlight configured to illuminate a group of display pixels when none of the group of display pixels are to be visible; and,
means for turning on the backlight when at least one display pixel of the group of display pixels is to be visible.

19. The apparatus of claim 17, where the shuttering means comprises means for activating at least one barrier in a parallax barrier network.

20. The apparatus of claim 17, where the at least one display pixel comprises a first set of display pixels, and
the apparatus further comprises, means for shuttering a second set of display pixel in the plurality of display pixels while the first set of display pixels are unshuttered and means for refreshing the second set of display pixel while the first set of display pixels are unshuttered.
